(19) United States
(12) Patent Application Publication
(10) Pub. No.: US 2001/0045879 A1
(43) Pub. Date: Nov. 29, 2001

(54) Combined tripping device for a circuit breaker

(76) Inventors: Matthias Reichard, Neumunster (DE); Walter Felden, Neumunster (DE)

Correspondence Address: PATENT OPERATION, GENERAL ELECTRIC COMPANY, 41 WOODFORD AVENUE, PLAINVILLE, CT, 06062

(21) Appl. No.: 09/681,323

(22) Filed: Mar. 16, 2001

(30) Foreign Application Priority Data
Mar. 17, 2000 (DE) 100 13 161.1

(51) Int. Cl. H01H 9/00

(52) U.S. Cl. 335/172

(57) ABSTRACT

A tripping device for a circuit breaker with contacts that are arranged in a housing and can be separated from one another by actuating a tripping shaft of a switchdevice contains a blowchannel that is arranged in the housing and assigned to the contacts. The tripping device also contains a rotatably arranged lever that is functionally connected to the tripping shaft. A magnet system that subjects the lever to an excursion in order to actuate the tripping shaft is able to act upon the lever. A baffle surface that is arranged on the lever and arranged in the blowchannel promotes the excursion of the lever due to the fact that it is subjected to a pressure impulse in the blowchannel.

### FIELD OF THE INVENTION

The invention pertains to a combined tripping device for a circuit breaker. More particularly to a tripping device having a lever actuated by either a magnet or pressure to trip the circuit breaker.

### BACKGROUND OF THE INVENTION

In order to make it possible for circuit breakers to protect lines from a shortcurrent, one utilizes a tripping device with a magnet system. In systems of this type, a magnetic field that exerts a magnetic force upon an armature is generated with the current to be monitored. When the magnetic force becomes sufficiently high, the armature moves into a tripping position and actuates a switchdevice that separates the contacts of the circuit breaker.

At very high current peaks, however, the magnetic tripping process may not take place sufficiently fast. This can result in damage to the circuit breaker as well as the downstream devices.

There also exist circuit breakers that are equipped with contacts for realizing an instantaneous tripping in case of a short circuit, with said instantaneous tripping being realized in the form of an electrodynamic repulsion. In case of an instantaneous tripping, an arc is created that extends between the contacts and causes a rapid pressure increase in the housing that accommodates the contacts.

The housing is connected to a pressure chamber that is closed with a movable piston. Due to the pressure increase in the housing and in the pressure chamber, the piston is displaced and acts upon a switchdevice that switches off the circuit breaker once a predetermined pressure is exceeded.

The pressure increase caused by the arc takes place very fast, but the design of a pressure chamber that is sealed with a displaceable piston requires a corresponding technical expenditure for observing the required dimensional tolerances, larger housing dimensions and a correspondingly pressurehousing.

Consequently, there is a demand for a tripping device for a circuit breaker which has a simple design and allows a very fast and reliable tripping of the circuit breaker.

### SUMMARY OF INVENTION

The present invention relates to a tripping device for a circuit breaker with contacts that are arranged in a housing and can be separated from one another by actuating a tripping element of a switchdevice contains a blowchannel that is arranged in the housing and assigned to the contacts. The tripping device also contains a lever that is functionally connected to the tripping element. A magnet system acts upon this lever, with said magnet system subjecting the lever to an excursion in order to actuate the tripping element. A baffle surface that is arranged on the lever and assigned to the blowchannel promotes the excursion movement of the lever due to the fact that it is subjected to a pressure surge in the blowchannel.

### BRIEF DESCRIPTION OF DRAWINGS

The invention is described in greater detail below with reference to preferred embodiments that are illustrated in the figures. The figures show:

FIG. 1 illustrates a perspective view of a circuit breaker unit with a tripping device;

FIG. 2 illustrates a side plan view of the circuit breaker shown in FIG. 1;

FIG. 3 illustrates a sectional view of the circuit breaker shown in FIG. 2; and,

FIG. 4 illustrates a side plan view of a circuit breaker unit with an alternate tripping device.

### DETAILED DESCRIPTION

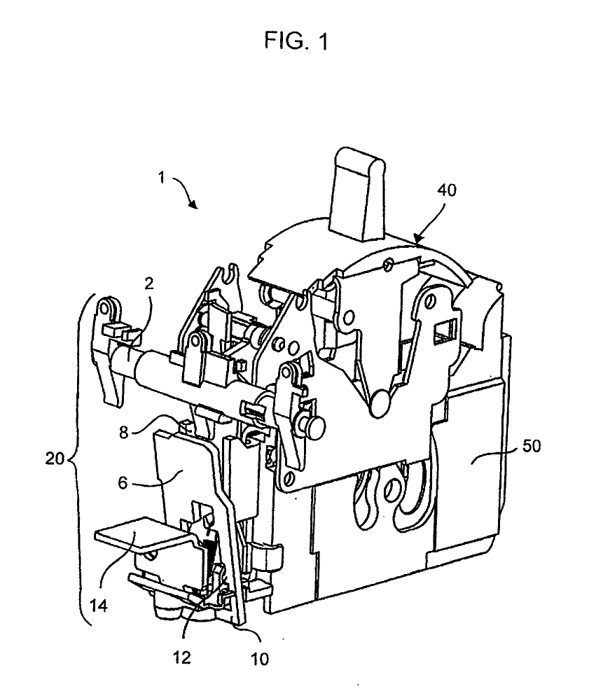

FIG. 1 shows a perspective representation of a circuit breaker unit 1 that is provided with a switchdevice 40 and a tripping device that is identified by the reference symbol 20. The circuit breaker unit contains a housing 50, on which the switchdevice 40 and the tripping device 20 are arranged. The switchdevice 40 and the tripping device 20 are functionally connected by a tripping shaft 2. An actuation of the tripping shaft 2 trips the switchdevice 40 that interrupts the corresponding circuit. The switchdevice also contains a mechanism that makes it possible to close the contacts again after the circuit breaker was tripped and the cause for the tripping process was repaired.

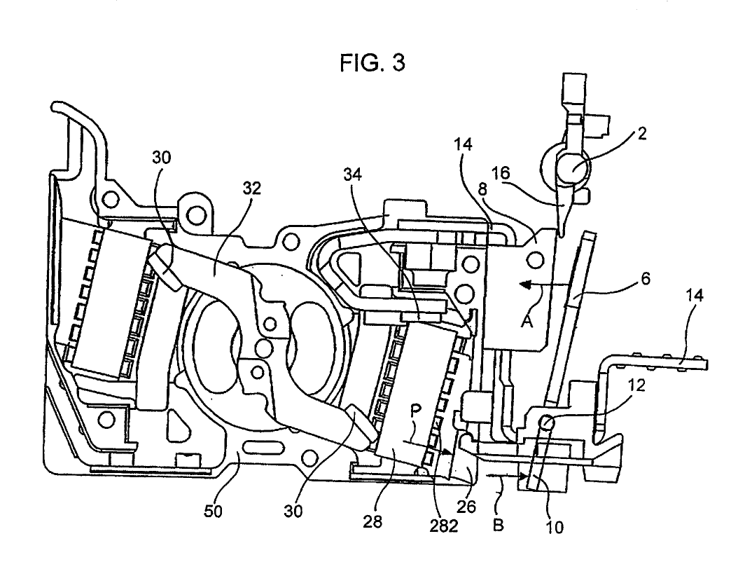

FIG. 3 shows the housing 50 that is composed of two housing halves. The housing 50 encloses a hollow space, in which the electric elements 30, 32, 34, 28 of the circuit breaker are accommodated. Various bearing points for the corresponding elements that are described below are arranged on the housing. Generally speaking, the term arranged on the housing which is used in the following description means that corresponding bearing pins, bearing openings, etc., are formed on the housing. The housing is manufactured from an insulating material, preferably a plastic.

The interior of the circuit breaker is described in detail below with reference to FIG. 3. FIG. 3 indicates that the circuit breaker contains a housing, on which the tripping device is arranged (right side in FIG. 3). A contact bridge 32 that is rotatably held on a rotor and can be turned in the clockwise direction as well as the counterclockwise direction is situated in the housing.

The contact bridge is provided with movable contacts 30 on both of its ends, with said movable contacts being able to cooperate with rigid contacts 34. When the switch is closed, the contact bridge is turned by approximately 90 E in the counterclockwise direction referred to the illustration shown in FIG. 3, i.e., the movable contact 30 contacts the rigid contact 34. A current conductor (not shown) that also contains a rigid contact is provided on the side that is situated diagonally opposite the rigid contact 34 in FIG. 3, i.e., on the bottom left in FIG. 3. This rigid contact contacts another movable contact of the contact bridge 32 when the aforementioned contacts 30, 34 are closed. This means that the current to be monitored by the circuit breaker flows through the contact bridge 32.

A tripping shaft 2 that cooperates with a notswitchdevice which is described below is also shown on the top right of FIG. 3. One can ascertain that a catch 16 which may lie in the moving path of a lever 6 of the tripping device is arranged on the tripping shaft 2 of the tripping device. The function of the tripping device is described below. FIG. 3 also indicates that an arc quenching chamber 28 is assigned to each contact pair. The arc quenching chamber is provided with suitable plates (deion plates) that are arranged essentially parallel to one another in the chamber and identified by the reference symbol 282 in FIG. 3.

In this context, it should be noted that the rotor or the contact bridge 32, respectively, is prestressed into the respective end position by means of springs, i.e., the rotor overcomes the point of the highest spring deformation during the rotation such that a bistable configuration is achieved. In other words, the contact bridge 32 is held in the closed position and in the open position by means of a spring force. This is important for the function of the circuit breaker with respect to the fact that a separation of the contacts from one another can take place as described below when an overcurrent occurs.

The tripping process is described in detail below with reference to FIG. 3. The switchdevice (not shown) forms a ratchet mechanism, a latching mechanism or the like which is able to turn the rotatable contact bridge 32 in the clockwise direction when the circuit breaker is tripped. The tripped condition is illustrated in FIG. 3.

The rigid contact 34 is arranged on the current conductor 14. The movable contact 30 arranged on the contact bridge 32 can be brought in contact with the rigid contact 34 of the current conductor 14 by turning the contact bridge 32 in the counterclockwise direction in FIG. 3. The movable contact 30 arranged on the other end of the contact bridge 32 is simultaneously brought in contact with the rigid contact (not shown) of an outgoing current conductor (not this means that the circuit is closed by the circuit breaker unit 1. In this closed condition of the circuit breaker, the switchdevice is prestressed in the switchdirection. If the tripping shaft 2 of the tripping device is turned, the switchdevice is released such that the contact pairs 30, 34 are separated, i.e., the circuit breaker is switched off.

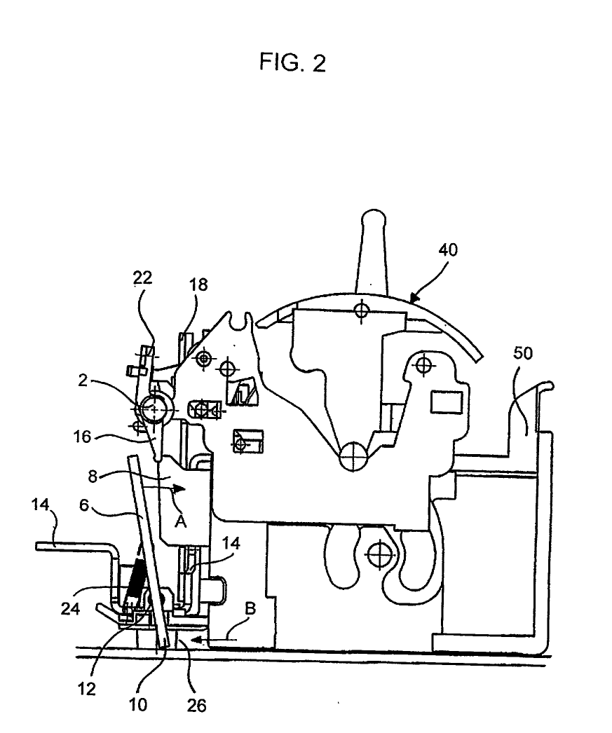

The tripping device is described in detail below with reference to FIGS. 1 In addition to the tripping shaft 2, the tripping device 20 also contains a yoke 8 that encompasses the current conductor 14, with the limbs of said yoke facing an armature or lever 6. The lever 6 can be turned about a fulcrum 12. FIG. 2 indicates that the lever 6 is extended beyond the fulcrum 12 and forms a baffle surface 10. This baffle surface is assigned to a blowchannel 26 that is described below.

The lever 6 is prestressed into its idle position by a tension spring 24, with the end of the lever that is situated opposite the baffle surface 10 being arranged opposite a catch 16 of the tripping shaft 2. FIG. 2 also shows a bimetal element 18 that is essentially arranged parallel to a section of the current conductor 14 that extends vertically in FIG. 2, with the bimetal element being able to engage with a projection 22 of the tripping shaft 2.

Based on the closed condition of the contacts 30, 34, the tripping process is described below with reference to FIG. 3. A current that flows through the current conductor 14 generates a magnetic field around the current conductor, with the magnetic field being directed and amplified by the yoke 8 such that a magnetic force is exerted upon the lever 6 in the direction of the arrow A. Once the current flowing through the current conductor 14 exceeds a predetermined value, the lever 6 is subjected to an excursion against the force of the spring 24 due to the magnetic force between the yoke and the lever 6, namely to such a degree that the lever contacts the catch 16 of the tripping shaft 2. This causes a rotation of the tripping shaft 2 that trips the switchdevice 40 (FIGS. 1 and 2) and switches off the circuit breaker as described above.

If a high current peak occurs, the contacts 30, 34 are directly pressed apart by means of an electrodynamic repulsion. The electrodynamic repulsion takes place due to the magnetic fields around the current conductor 14 (lower horizontal section) and the contact bridge 32 that is arranged parallel to the current conductor 14 when the rigid contact 34 and the movable contact 30 on the contact bridge 32 are closed. If a higher current flows through the circuit breaker, a current flows through two parallel conductors (current conductor 14 and contact bridge 32) in opposite directions. Identically directed magnetic fields that repulse one another are created around the conductors. Once this current becomes high, the magnetic fields become so intense that they press the contacts apart against the closing force of the contacts. This closing force is generated by a spring mechanism. The contact bridge 32 is slightly turned in the clockwise direction. During this process, an arc that bridges the gap formed between the contacts is generated between the contacts 30, 34. An arc quenching chamber 28 is assigned to each contact pair 30, 34 in order to prevent an excessive propagation of the arc and to rapidly quench said arc, respectively.

The higharc abruptly (approximately 0.5 ms) increases the pressure of the air or the gas in the quenching chamber 28. The pressure in the arc quenching chamber 28 can be released into the surroundings through the blowchannel 26. This pressure drop takes place in the form of a pressure impulse (arrow P) or a pressure wave that travels through the blowchannel 26 very rapidly. The baffle surface 10 of the lever 6 is arranged in the blowchannel 26 and subjected to the pressure impulse. During this process, the kinetic energy of the pressure wave, i.e., of the medium flowing in the blowchannel 26, is converted into a dynamic pressure on the side of the baffle surface 10 that faces the arc quenching chamber 28. The standard pressure is higher than the static pressure on the rear side of the baffle surface 10. The lever 6 is subjected to an excursion in the tripping direction by a force (arrow B) that is generated due to this differential pressure and exerted upon the baffle surface 10.

With respect to the function of the device, it should be emphasized that the described instance pertains to a dynamic flow process that leads to an excursion of the baffle surface. Due to the impact flow that exclusively acts in a dynamic fashion, a seal between the baffle surface and the blowchannel wall can be eliminated. In this respect, it suffices if the baffle surface is arranged such that it can be moved essentially transverse to the direction of the pressure impulse. Consequently, expenditures with respect to industrial manufacture are advantageously low because no narrow tolerances or fits have to be observed.

The baffle surface can also be arranged outside of the blowchannel in the vicinity of the outlet opening. It suffices if the pressure wave impacts on the baffle surface with a sufficient speed.

The two aforementioned tripping types or tripping forces occur simultaneously such that the tripping caused by the magnetic force acting between the lever 6 and the yoke 8 is additionally promoted by the tripping force caused by the impact of the pressure pulse on the baffle surface 10 of the lever 6. The opposing forces (arrows A and B) act upon the lever 6 on two different sides of the fulcrum 12, with said forces being added to obtain a total torque about the fulcrum 12 which is available for realizing the excursion of the lever. Consequently, the torque available for overcoming the moment of inertia of the lever which increases due to the fast movement of the lever is also increased.

This means that this arrangement makes it possible to achieve a faster tripping process than in instances, in which only a magnetic force is utilized. This is particularly advantageous if high current peaks occur very fast or in an impulsefashion because these current peaks can easily lead to damage of the circuit breaker or the downstream devices.

The circuit breaker or circuit breaker unit shown in FIGS. 1 is also provided with an overload protection that is equipped with a bimetal element 1 8. According to FIG. 2, the bimetal element 18 is arranged parallel to a section of the current conductor 14 which extends vertically in FIG. 2. If a current (overload) that is not sufficiently high for initiating the magnetic tripping process or the combined magnetic tripping and pressure impulse tripping process but higher than the desired current constantly flows through the current conductor 14, the current conductor 14 is gradually heated.

The heated current conductor 14 delivers part of its heat to the bimetal element 18 arranged adjacent to the current conductor. The thusly heated bimetal element 18 begins to bent toward the left in FIG. 2 and actuates or turns the tripping shaft 2 in the tripping direction with the aid of the projection 22. As its temperature increases, the bending or the excursion of the bimetal element from its idle position also increases. Once the excursion of the bimetal element or the turning of the tripping shaft, respectively, exceeds a predetermined value, the tripping device initiates the switchprocess that switches off the circuit breaker.

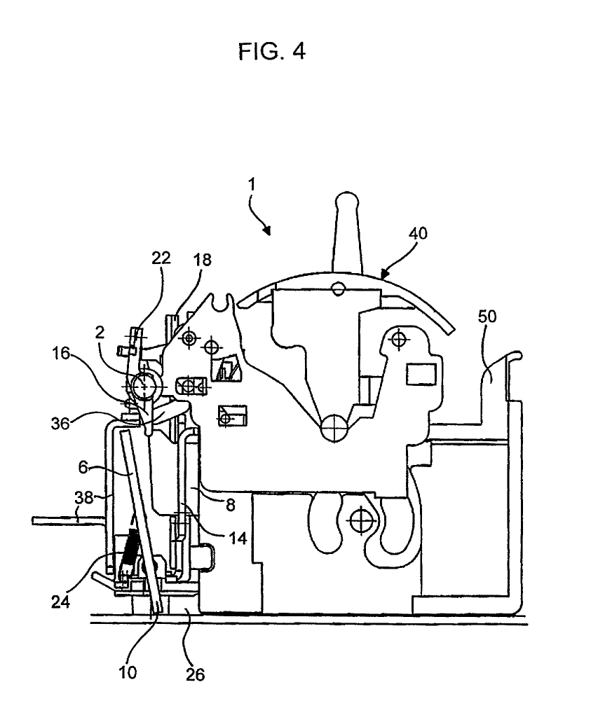

A modified embodiment of the tripping device is shown in FIG. 4. In this case, parts or elements that fulfill the same function are identified by the same reference symbols as in FIG. 1 The modification shown in FIG. 4 only differs from the previously described tripping device due to the different heating of the bimetal element 18.

FIG. 4 indicates that the incoming current conductor or the terminal 38 is connected to the bimetal element 18 via a line 36. The bimetal element 18 is electrically connected to the current conductor 14 within the region of its lower end in FIG. 4. The current conductor 14 extends through the yoke 8 and functions analogous to the previous description of FIGS. 1. In this case, the current to be monitored flows through the bimetal element 18, with the bimetal element being directly heated by this current. If the current flowing through the bimetal element becomes excessively high, the temperature of the bimetal element exceeds the tripping value and the bimetal element 18 bends to such a degree that it turns the tripping shaft 2 in order to trip the switchdevice 40.

The remaining arrangement, in particular, the baffle surface 10 on the lever 6 which is arranged in the blowchannel 26 as well as its cooperation with the magnetic tripping process, corresponds to the previous description of FIG. 1 Consequently, this arrangement functions analogously, i.e., a repeated description is unnecessary.

Individual functions and advantageous embodiments of the tripping device are described below.

Deion plates 282 of steel are arranged in the arc quenching chamber 28 in order to quench the arc. The plates 282 are arranged diagonally in the housing parallel to one another and thusly provide a superior guide for the gases that expand due to the arc in the direction of the blowchannel 26. Due to this measure, the effect of the pressure wave or the pressure impulse can be intensified.

The driver section of the lever 6 and the catch 16 make it possible to actuate the tripping shaft 2 in the tripping direction independently of a movement of the lever 6. Due to this measure, a different type of tripping process, e.g., by the bimetal element 18, can take place without affecting the remaining tripping device. This may prove practical if the reason for the tripping should be permanently displayed by a suitable means (drag lever and window or the like).

In addition, the baffle surface is formed by simply extending the lever 6 beyond the fulcrum 12. Consequently, the tripping device can be realized with the aid of a simple constructive measure without increasing the number of components. If applicable, the baffle surface may also be realized in the form of a flap that closes the blowchannel and prevents the admission of foreign materials.

It should be emphasized that the invention can also be applied to other magnet systems, i.e., the invention is not limited to the described arrangement with a current conductor in a Uyoke. It would also be possible to utilize a coil with a core or the like.

The previous description only pertained to a singlecircuit breaker unit. A multicircuit breaker can be realized in the form of a parallel arrangement of a corresponding number of circuit breaker units, with the switchdevice being assigned to one pole, several poles or all poles. Analogously, the tripping shaft can be equipped with a tripping device for switching off one pole, several poles or all poles.

In the previous description, a lever was utilized, in which the respective lever arms are subjected to oppositely directed magnetic forces and pressure forces, and in which the respective forces are converted into a rotation in one direction. However, the arrangement may also be chosen such that the magnetic forces and the pressure forces act upon the same lever arm of the lever in the same direction.

In addition, the lever does not necessarily have to be rotatable. A linearly displaceable lever that is subjected to the magnetic force and the pressure force may also be provided.

Although the present invention has been described with reference to certain embodiments, it will be appreciated that these embodiments are not limitations and that the scope of the invention is defined by the following claims.

What is claimed is:

1. A circuit breaker comprising:
a housing;
a switch-off device coupled to said housing;
a pair of separable contacts arranged in said housing, said pair of contacts separating in response to said switchdevice;
a blowchannel arranged in the housing and adjacent to said pair of contacts;
a lever connected to said switchdevice, said lever including a baffle surface coupled said blow-out channel; and,
a magnet system that acts upon said lever and subjects the lever to an excursion in response to said switchdevice.

2. A circuit breaker of claim 1 wherein said lever is arranged in a rotatable fashion.

3. A circuit breaker of claim 2 wherein said lever has a fulcrum arranged between a first lever arm responsive to said magnet system and a second lever arm responsive to a pressure impulse.

4. A circuit breaker of claim 3 wherein said baffle surface forms said second lever arm of the lever.

5. A circuit breaker of claim 4 wherein said magnet system includes a yoke arranged opposite said lever, said lever being magnetically attracted to said yoke.

6. A circuit breaker of claim 5 wherein said yoke includes a current conductor that supplies a current to the contacts of the circuit breaker.

7. A circuit breaker of claim 6 further comprising:
a tripping shaft coupled to said lever,
a driver mechanism coupled to tripping shaft such that said tripping shaft moves independently of said lever.

8. A circuit breaker of claim 7 wherein said driver mechanism includes a catch.

9. A circuit breaker of claim 8 wherein said driver mechanism is arranged on one end of said first lever arm.

10. A circuit breaker of claim 9 wherein said lever is operably connected to a spring element that bias the lever into an idle position.

11. A circuit breaker of claim 10 wherein said baffle surface at least partially blocks of the channel cross section.

12. A circuit breaker of claim 10 wherein said baffle surface is arranged outside said blowchannel adjacent a blow-out channel outlet opening.

13. A circuit breaker of claim 6 wherein said current conductor is arranged adjacent a bimetal strip coupled to the tripping shaft.

14. A circuit breaker of claim 6 wherein said current conductor is formed by a bimetal strip, said bimetal strip being coupled to said tripping shaft.

15. A circuit breaker of claim 12 wherein said blowchannel is adjacent to a arc quenching chamber.

16. A circuit breaker of claim 15 wherein said pressure impulse is generated by an arc that extends between said pair of separable contacts during an electrodynamic repulsion.
